(19) United States
(12) Patent Application Publication
(10) Pub. No.: US 2004/0211043 A1
(43) Pub. Date: Oct. 28, 2004

(54) Method for increasing the maximum dielectric strength in aluminium electrolyte capacitors

(76) Inventor: Norbert Will, Heidenheim (DE)

Correspondence Address: FISH & RICHARDSON PC, 225 FRANKLIN ST, BOSTON, MA, 02110, US

(21) Appl. No.: 10/479,355

(22) PCT Filed: May 3, 2002
(86) PCT No.: PCT/DE02/01608

(30) Foreign Application Priority Data
May 30, 2001 (DE) 101 26 329.5

(51) Int. Cl. H01G 9/00

(52) U.S. Cl. 29/25.03

(57) ABSTRACT

Method for producing aluminium electrolytic capacitors with an increased dielectric strength, in which a suspension (25 and 30) is applied on the cut edges and spacers (5) of a capacitor comprising alternate layers of electrode films (1 and 10) and spacers (5) which are situated in between and are impregnated with electrolyte solution, said suspension forming a gel layer (35) with an increased dielectric strength as a result of diffusion of the electrolyte solution.

Aluminum electrolytic capacitors comprise at least two layers of aluminum films which function as anode and cathode. A spacer impregnated with an operating electrolyte is arranged between the aluminum films. The anode film is provided with a dielectrically acting oxide layer (forming layer) and is produced, if appropriate, from relatively large formed film tracks.

The dielectric strength of aluminum electrolytic capacitors is essentially limited by the dielectric oxide layer, the electrolyte and the spacer, which may be produced from paper layers or plastic film. The paper layers limit the current of the mobile ions present in the electrolyte and thus cause the electrolytic capacitor to have a higher peak dielectric strength. Weak points with regard to the peak dielectric strength are primarily points of the anode at which the electrolyte makes contact therewith without a paper layer that increases the series resistance. In this context, mention should be made primarily of the anode cut edges. They are in direct contact with the electrolyte and are not covered by a spacer. Therefore, numerous efforts have been made to apply materials which increase the series resistance to the anode cut edges.

The patent specification EP 0 325 919 discloses methods in which fine-grained material, for example amorphous silicon dioxide (trade name: Aerosil), obtained by oxyhydrogen gas hydrolysis is added to the operating electrolyte. The Aerosil is predominantly filtered out at the spacers, so that it remains during impregnation at the weak points of the capacitor, e.g. the cut edges of the electrodes, and thus yields an electrolyte mixture with a higher dielectric strength. The disadvantage of this method is that, as a result of the addition of Aerosil, the viscosity of the operating electrolyte is not only selectively increased at the cut edges but also at other locations, which leads overall to a reduction of the conductivity of the electrolyte mixture. Furthermore, the viscosity of the electrolyte must also in each case be coordinated individually with the size of the capacitors in order to enable relatively large capacitors to be impregnated as well. In practice, this has the effect that it is necessary to use various electrolyte mixtures in production, which is more cost-intensive and more complicated than using just one electrolyte.

Other variants disclosed in the patent specification EP 0 325 919 provide for fine-grained material additionally to be applied to the capacitor in dry form or in gel form. This has the disadvantage that, on account of the high viscosity of the material, it is not possible to achieve complete coverage of the cut edges and so it is not possible to achieve a reliable increase in the peak dielectric strength of the electrolytic capacitor.

Therefore, it is an aim of the present invention to provide a fast, cost-effective and reliable method for increasing the peak dielectric strength of electrolytic capacitors which avoids the disadvantages mentioned.

This object is achieved by means of a method according to claim 1. The subclaims relates to advantageous refinements of the method.

In contrast to the conventional methods mentioned above, in the case of the method according to the invention, no highly viscous or solid substances are applied to the cut edges of the electrodes and spacers or added to the electrolyte. Rather, in the case of the invention, a liquid suspension is applied to the cut edges of the capacitor, said suspension forming a gel with an increased dielectric strength only on account of the diffusion of the electrolyte into the suspension. The invention and its advantages over the conventional methods will be explained in detail below.

In the case of the method, firstly the capacitor is impregnated with the electrolyte solution by means of a simple impregnation corresponding to the prior art. This may be done by immersing the capacitor in an electrolyte immersion bath. As a consequence of the impregnation, a liquid film of the electrolyte solution also advantageously remains on the cut edges of the electrode films (see FIG. 1A). After the impregnation, according to the invention, a fine-grained, electrolyte-compatible material is suspended in a liquid which can take up a larger quantity of the insoluble fine-grained material than the electrolyte solution without becoming solid in the process. The fine-grained material and the suspending liquid should advantageously not impair the electrical properties of the electrolyte mixture. By way of example amorphous silicon dioxide (Aerosil) is used as the insoluble material. In this case, the concentration range of the Aerosil in the liquid is chosen so as to give rise to a stable suspension which does not exhibit a tendency toward gelation but becomes solid (gels) when electrolyte solution is added.

Use is preferably made of relatively nonpolar liquids as suspending agents, such as glycol or gamma-butyrolactone, which can take up a larger quantity of Aerosil than relatively polar solvents without becoming solid in the process. In this case, the suspending agent may advantageously also be a constituent of the electrolyte solution since it mixes with the electrolyte solution and should therefore not impair the properties thereof. Glycol or gamma-butyrolactone are appropriate for this reason, too, since they are often contained in electrolyte solutions.

The capacitor impregnated with the electrolyte solution is subsequently brought into contact with the suspension, e.g. immersed in the suspension. The suspension penetrates into the gaps between the spacers and the electrode films and begins to mix with the electrolyte solution which, on account of the impregnation operation described above, is situated on the cut edges of the spacers and electrode films (see FIG. 1B). In the case of average particle diameters chosen to be relatively large (generally larger than 10 nm) diffusion of the insoluble material is negligible, while the electrolyte diffuses into the suspension. As a consequence thereof, the concentration of the insoluble material at the interface between the electrolyte solution and the suspension remains the same, while the concentration of the operating electrolyte in the suspension increases on account of diffusion. This leads to a gradual formation of a gel layer on the cut edges of the spacers and electrodes (see FIG. 1C). The capacitor may subsequently be removed from the suspension bath. A gel layer remains on the cut edges of the electrodes and spacers and selectively increases the dielectric strength of the electrochemical capacitor at these weak points, while the ungelled suspension drips away.

In contrast to the abovementioned methods corresponding to the prior art, in the case of the method according to the invention, a liquid suspension is applied to the cut edges of the capacitor, thereby enabling a reliable coverage even in very small interspaces and undercuts. This cannot be ensured when applying solid or highly viscous material of a gel, for example, as corresponds to the prior art.

Compared with other methods in which the fine-grained material is already added to the operating electrolyte with which the capacitor is subsequently impregnated, the method according to the invention affords the advantage that the insoluble material only selectively covers the cut edges and does not lead to a higher viscosity of the operating electrolyte and thus to a lower conductivity. In the case of the method according to the invention, moreover, it is possible to use a standard electrolyte and also a uniform suspension for all sizes of capacitors, which enables simplified and less expensive production.

The gelation required for increasing the dielectric strength at the cut areas of the electrodes takes place, according to the invention, only after the application of the suspension. In this case, the different diffusion speeds of the electrolyte and of the solid material at the interface between the electrolyte and the suspension are utilized for targeted formation of a gel layer. Since the formation of the gel layer generally extends over a period of several hours on account of the slow diffusion of the electrolyte, the liquid suspension can penetrate even into very small interspaces in the region of the anode cut edges in this time, thereby achieving a particularly reliable coverage and thus also a high dielectric strength.

The method according to the invention is explained in more detail below with reference to a few illustrations and exemplary embodiments. The figures serve only to provide a better understanding of the invention and are therefore simplified diagrammatically and not true to scale.

### BRIEF DESCRIPTION OF THE FIGURES

FIGS. 1A to 1C show longitudinal sections through a capacitor at different stages of the method according to the invention.

FIGS. 2A to 2D show the variation of the concentrations of the liquid and solid substances on account of diffusion during the gelation according to the invention at the cut edges of the capacitor.

### DETAILED DESCRIPTION OF THE FIGURES

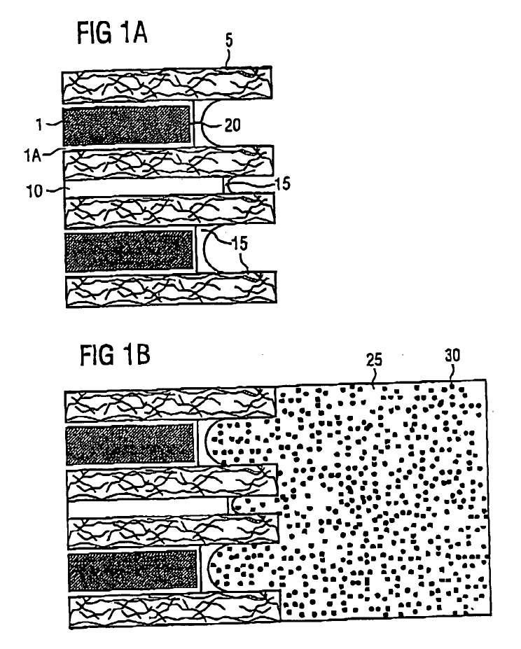

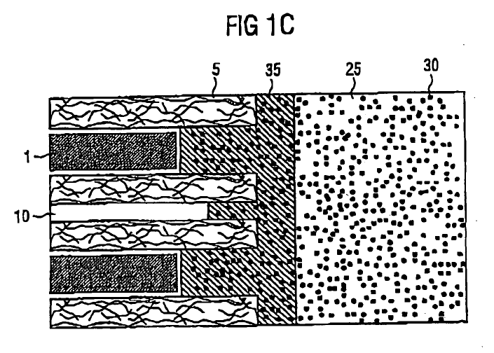

FIG. 1A shows a longitudinal section through a capacitor after impregnation with an operating electrolyte in an immersion bath. The capacitor comprises, by way of example, anode films 1 provided with a forming layer 1A, in between which are wound cathode films 10 separated by porous spacers 5. It can be seen that the electrolyte solution 15 has both penetrated into the spacers 5 and covers the cut edges 20 of the anode and cathode films.

FIG. 1B shows a longitudinal section through a capacitor winding after immersion in the suspension bath. The suspension, comprising a solid, fine-grained material 30 suspended in a liquid (suspending agent) 25, comes into contact with the electrolyte solution 15 in the spacers and on the cut areas of the electrode films.

FIG. 1C shows a gel layer 35 according to the invention, which has formed on the capacitor after the end of the process of immersion in the suspension. The gel layer completely covers the cut edges of the electrode films and the spacers. A sharp interface has formed between the solid gel and the still liquid suspension.

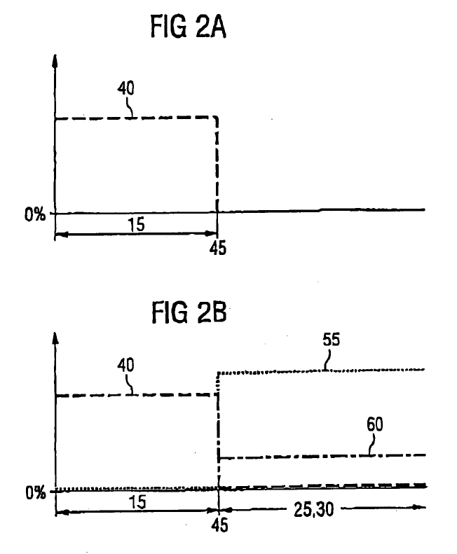

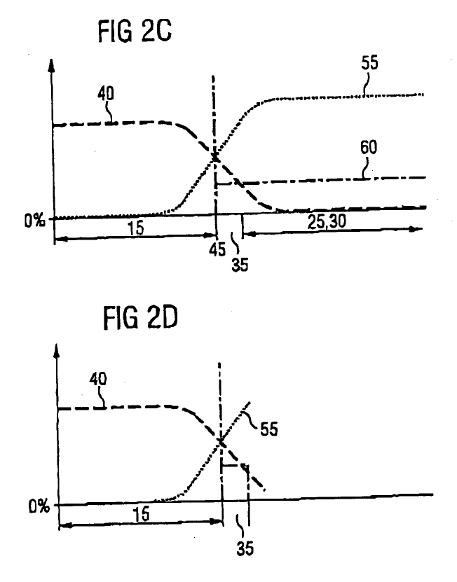

FIG. 2A shows an exemplary concentration 40 of the operating electrolyte 15 in a capacitor after impregnation with the operating electrolyte. In this illustration and in all the following illustrations 23 to 2D, the concentrations of the substances or insoluble materials involved are specified on the vertical axis, while the horizontal axis specifies a spatial coordinate representing a longitudinal section in the region of the porous spacer through the various layers involved in the gelation process. In this case, the provided with the reference symbol 40 concentration of the operating electrolyte 15 in the spacer impregnated with the electrolyte, while the line 45 identifies the location of the cut areas of the spacer.

FIG. 2B shows a concentration profile of all the substances involved directly after immersion of the impregnated capacitor in the suspension (25, 30) with a specific concentration 55 of the suspending agent and a concentration 60 of the insoluble material. It can be seen that before the individual solutions are mixed, there is a sharp interface present which demarcates the electrolyte solution 15 (illustrated on the left in the figure) from the suspension. The concentrations of suspending agent and solid are considered separately in this case even though both the electrolyte and the suspension are still “liquid”.

FIG. 2C shows the concentration profile at the end of the process of immersion in the suspension. It can be seen that both the suspending agent (for example glycol) has diffused into the electrolyte and, conversely, the electrolyte has diffused into the suspension. On account of the particle size, diffusion of the insoluble solid material has scarcely taken place. As can be seen in FIG. 2D, a solid gel layer 35 has formed on the cut areas 45 of the spacers since the gelation concentration of insoluble material has been exceeded on account of the diffusion of the electrolyte into the suspension. Both the operating electrolyte in the porous spacers 15 and the suspension (25, 30) situated above the gel (illustrated on the right in the figure) are still liquid.

FIG. 2D shows the concentration profile after the removal of the capacitor from the suspension bath. It can be seen that the residual ungelled suspension has dripped away and only the solid gel remains on the capacitor.

### EXEMPLARY EMBODIMENTS

### EXAMPLE 1

A capacitor is produced by winding up two layers of aluminum films, of which the film which serves as anode is covered with an oxide layer acting as a dielectric. Situated between the aluminum films is a layer of paper as spacer, which has been impregnated in an operating electrolyte. The operating electrolyte comprises, by way of example, 9 to 11 mol of ethylene glycol, 2 to 5 mol of boric acid, 0.1 to 0.5 mol of adipic acid, 0.9 to 1.5 mol of ammonia, 0.05 to 0.15 mol of phosphoric acid and 4.0 to 6 mol of water. In order to produce the suspension for the method according to the invention, in an advantageous manner, Aerosil is used as insoluble material and glycol is used as suspending agent, it being possible to set the weight ratio of glycol:Aerosil in the suspension to e.g. 80:20. Since the operating electrolyte can generally take up only between 10 and 16% by weight of Aerosil, gelation then occurs in the event of diffusion of the operating electrolyte into the suspension. The capacitor winding is immersed in the suspension, so that a gel layer according to the invention can form within a few hours (see illustration 2b).

### EXAMPLE 2

Exemplary embodiment analogous to Example 1, gamma-butyrolactone rather than glycol being used as suspending agent.

### EXAMPLE 3

Exemplary embodiment analogous to Examples 1 and 2, in which case the insoluble material used may be, rather than Aerosil, other suitable fine-grained materials such as, for example, kieselguhr, hydragillite (Al(OH)₃) and cellulose fibers and all fine-grained materials that can be obtained in pure and electrolyte-compatible form.

The exemplary embodiments only represent examples. Variations of the method according to the invention are possible both with regard to the composition of the electrolytes and with regard to the insoluble materials and liquids used for the suspension.

1. A method for producing an electrolytic capacitor with an increased dielectric strength, comprising
constructing a capacitor containing electrode films and porous spacers, each of the porous spacers being situated in between every two electrode films, and impregnating the capacitor with an operating electrolyte;
contacting the capacitor at least at cut edges of the electrode films and the spacers, with a suspension of a fine-grained, electrolyte-compatible material in a suspending liquid, wherein the suspending liquid differs from the operating electrolyte and is selected such that it can take up a larger quantity of the fine-grained, electrolyte-compatible material than the electrolyte solution without forming a gel; and
diffusing the operating electrolyte into the suspension to form a gel layer with an increased dielectric strength at the cut edges of the electrode films and the spacers.

2. The method as claimed in claim 1, wherein
the fine-grained, electrolyte-compatible material has an average primary particle size of approximately 1 nm to 1 μm.

3. The method as claimed in claim 1, wherein
the fine-grained, electrolyte-compatible material is silicic acid, kieselguhr, hydrargillite (AL(OH)₃), or cellulose fibers.

4. The method as claimed in claim 1, wherein
the suspending liquid is glycol or gamma-butyrolactone.

5. The method as claimed in claim 1, wherein
the suspending liquid is a constituent of the operating electrolyte.

6. The method as claimed in claim 1, wherein
the suspension contains up to 20% by weight of silicic acid in glycol.

7. The method as claimed in claim 1, wherein
the porous spacers are paper.

8. The method as claimed in claim 3, wherein
the suspending liquid is glycol or gamma-butyrolactone.
